(19) United States
(12) Patent Application Publication
(10) Pub. No.: US 2009/0124775 A1
(43) Pub. Date: May 14, 2009

(54) VINYLPYRROLIDONE POLYMER SOLUTION, PROCESS FOR PRODUCING THE SAME, AND METHOD OF HANDLING VINYLPYRROLIDONE POLYMER

(75) Inventors: Takashi Miyai, Osaka (JP); Yoshitomo Nakata, Hyogo (JP); Yasuhiro Matsuda, Hyogo (JP); Mitsuru Nakajima, Osaka (JP)

Correspondence Address: CONNOLLY BOVE LODGE & HUTZ LLP, 1875 EYE STREET, N.W., SUITE 1100, WASHINGTON, DC, 20006, US

(73) Assignee: NIPPON SHOKUBAI CO., LTD., Osaka (JP)

(21) Appl. No.: 11/718,758

(22) PCT Filed: Nov. 4, 2005
(86) PCT No.: PCT/JP2005/020313

§ 371 Date: Jan. 21, 2009

(30) Foreign Application Priority Data
Nov. 5, 2004 (JP) 2004-322786

(51) Int. Cl. C08F 26/10

(52) U.S. Cl. 526/264

(57) ABSTRACT

To provide a high concentration solution of a vinylpyrrolidone polymer having a low K value, which can be used in various applications such as medical applications and applications where coloring is problematic. A monomer component essentially containing N-vinylpyrrolidone, hydrogen peroxide, and ammonia are sequentially added to a copper catalyst-containing aqueous solvent and polymerized at 55 to 90° C., and the ammonia is used in an amount of 0.1 to 0.37% by weight based on the N-vinylpyrrolidone. As a result, a 40 to 60% by weight solution of a vinylpyrrolidone polymer having a K value of 60 or less, wherein the solution has: an N-vinylpyrrolidone content of 10 ppm or less relative to the vinylpyrrolidone polymer; an alkanol concentration of 100 ppm or less; and an ignition residue of 0.1% by weight or less, and a 50% by weight solution of the vinylpyrrolidone polymer has a hue (APHA) according to JIS-K3331 of 280 or less.

### TECHNICAL FIELD

The present invention relates to a high concentration solution of a vinylpyrrolidone polymer having a low K value according to Fikentscher method, a process for producing such a solution, and a method of handling a vinylpyrrolidone polymer using such a high concentration solution.

### BACKGROUND ART

A vinylpyrrolidone polymer in solution form is generally used when the polymer is used in various applications. However, because of advantages in terms of volumetric capacity in storage or transport, a method in which the polymer once converted into a powder is stored and transported and, at the time of use, dissolved in a solvent to be converted into a solution, is commonly used. However, for example, a 50% by weight or more high concentration solution is considered to be able to provide advantages in terms of volumetric capacity, which equal or, depending on bulk specific gravity, surpass those obtained in the polymer in powder form. Therefore, the polymer handled as a high concentration solution can be said to be in the most desirable embodiment because redissolution is not needed at the time of use and advantages in terms of volumetric capacity, which equal or surpass those obtained in the polymer in powder form, can be obtained.

In order to realize such handling as a high concentration solution, a polymerization method for obtaining a high concentration vinylpyrrolidone polymer solution needs to be established. However, it is not easy to obtain a high concentration solution of a vinylpyrrolidone polymer having a low K value according to Fikentscher method (hereinafter, also referred to as simply “K value”), that is, having a low molecular weight. That is, for example, aqueous solution polymerization of N-vinylpyrrolidone is conventionally performed using hydrogen peroxide as an initiator due to cost advantages. It is known that the concentration of the hydrogen peroxide is increased in order to obtain polyvinylpyrrolidone having a low molecular weight. However, if this polymerization reaction is performed at a high monomer concentration of more than 30% by weight, heat generated by the reaction is hard to control, which fails to secure safety. If the polymerization reaction is performed by a flow-through method in order to control the heat generation, high graft function of the hydrogen peroxide causes undesirable increase in molecular weight, which increases the K value of the obtained polyvinylpyrrolidone. There is also a problem in that the polyvinylpyrrolidone obtained by the polymerization reaction using a high concentration of hydrogen peroxide easily causes coloring.

A technology of using an aqueous compound containing an alkanol or sulfuric acid such as sulfite in a combined form as a polymerization modifier when radical solution polymerization is performed in an aqueous solvent using hydrogen peroxide as an initiator was disclosed as a method of obtaining a highly concentrated aqueous solution of a low molecular weight (low K value) homopolymer of N-vinylpyrrolidone (referring to Patent Document 1).

As a method of obtaining high concentration vinylpyrrolidone polymer solution, a method of concentrating a low concentration solution obtained in a polymerization by distillation and the like may be mentioned. However, such a method causes disadvantages such as deterioration in quality, for example, coloring caused by heating in distillation and the like, or disadvantages in productivity or costs.

### [Patent Document 1]

Japanese Kokai Publication No. Hei-11-71414

### DISCLOSURE OF THE PRESENT INVENTION

### Subject which the Invention is to Solve

However, in the technology of Patent Document 1, a great amount of the aqueous compound containing an alkanol or sulfuric acid such as sulfite in a combined form needs to be used in order to generate a polymer having a sufficiently low molecular weight (K value). Therefore, the polyvinylpyrrolidone high concentration aqueous solution disclosed in Patent Document contains a great amount of an alkanol or sulfite. However, in a polymer solution containing a great amount of an alkanol, toxicity of the alkanol is problematic, and therefore use of such a polymer solution in an application of medical products such as oral medicine and injectable solution is limited. Also, a polymer solution containing a great amount of sulfite is not used in applications in which an ignition residue according to Japanese pharmacopoeia is specified (to 0.1% or less), such as medical applications, because such a polymer solution has an extremely high ignition residue.

In the polymer solution containing a great amount of the alkanol, the content of the alkanol can be reduced by performing a step of removing the alkanol after the polymerization. However, such removal of the alkanol causes disadvantages in productivity or costs, and additionally, causes another problem in that coloring is generated by heating when the alkanol is removed. This coloring problem can be avoided utilizing the knowledge in which coloring can be suppressed using conventionally-known sulfite. Also Patent Document 1 discloses an example of obtaining a polymer solution hardly colored using sulfite in combination, but such a polymer solution obtained using sulfite in an amount enough to suppress the coloring still has the above-mentioned problem on ignition residue.

Thus, use of the high concentration polymer solution obtained in the technology described in Patent Document 1 is limited in specific applications such as medical applications and applications where coloring is problematic. There has been no report that a low K value vinylpyrrolidone polymer which can be used in medical applications, applications where coloring is problematic, and the like, is obtained as a high concentration solution. Accordingly, under the present situation, it is not impossible to handle such a vinylpyrrolidone polymer used in specific applications as a high concentration solution.

The problems to be solved by the present invention is to provide: a high concentration solution of a vinylpyrrolidone polymer having a low K value, which can be used in various applications including medical applications, applications where coloring is problematic; a process for producing such a solution; and a method of handling a vinylpyrrolidone polymer using such a polymer solution.

### Means for Solving the Subject

The present inventor made various investigations for solving the above-mentioned problems. As a result, the inventor found that when a monomer component essentially containing N-vinylpyrrolidone is polymerized, the monomer component, hydrogen peroxide in a specific amount, and ammonia in a specific amount are sequentially added in an aqueous solvent containing copper catalyst in a specific amount and polymerized at a specific temperature, thereby easily obtaining a 40 to 60% by weight high concentration solution of a vinylpyrrolidone polymer having a K value of 60 or less, wherein the solution has a residual N-vinylpyrrolidone content, an alkanol concentration, an ignition residue, an a hue (APHA) according to JIS-K3331 at 50% concentration, each satisfying a specific range. And the inventor determined that such a solution can solve all of the above-mentioned problems. As a result, the present invention has been completed.

That is, the vinylpyrrolidone polymer solution of the present invention is a 40 to 60% by weight solution of a vinylpyrrolidone polymer having a K value according to Fikentscher method of 60 or less, wherein the solution has: an N-vinylpyrrolidone content of 10 ppm or less relative to the vinylpyrrolidone polymer; an alkanol concentration of 100 ppm or less; and an ignition residue of 0.1% by weight or less, and a 50% by weight solution of the vinylpyrrolidone polymer has a hue (APHA) according to JIS-K3331 of 280 or less.

The process for producing a vinylpyrrolidone polymer solution of the present invention is a process for producing a 40 to 60% by weight solution of a vinylpyrrolidone polymer having a K value according to Fikentscher method of 60 or less, wherein a monomer component comprising N-vinylpyrrolidone, hydrogen peroxide, and ammonia are sequentially added to a copper catalyst-containing aqueous solvent and polymerized at 55 to 90° C., and the ammonia is used in an amount of 0.1 to 0.37% by weight based on the N-vinylpyrrolidone.

In the method of handling a vinylpyrrolidone polymer of the present invention, a vinylpyrrolidone polymer having a K value according to Fikentscher method of 60 or less is handled as the above-mentioned vinylpyrrolidone polymer solution of the present invention.

### DETAILED DESCRIPTION OF THE INVENTION

The vinylpyrrolidone polymer solution, the process for producing such a solution, the method of handling a vinylpyrrolidone polymer, according to the present invention, are mentioned below in more detail, but not limited to these explanations. It should be understood that the present invention is not limited to exemplary embodiments described below, and can be appropriately modified within a scope or spirit of the present invention.

### “Vinylpyrrolidone Polymer Solution”

In the present invention, the vinylpyrrolidone copolymer means a compound having a structural unit represented by the following formula (1), derived from N-vinylpyrrolidone, and specifically means a polyvinylpyrrolidone and/or a vinylpyrrolidone polymer. In the present invention, the vinylpyrrolidone polymer may be one or two or more species.

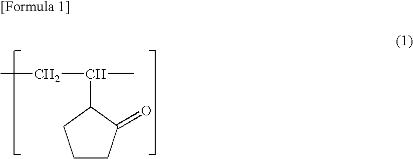

The above-mentioned vinylpyrrolidone copolymer may have, in addition to the structural unit represented by the above-mentioned formula (1), a constitutional unit derived from a monomer copolymerizable with N-vinylpyrrolidone, mentioned below in “production process of vinylpyrrolidone polymer solution”, for example. This structural unit derived from the monomer copolymerizable with N-vinylpyrrolidone may be one or two or more species.

In the above-mentioned vinylpyrrolidone copolymer, the proportion of each structural unit is not especially limited. The proportion of the structural unit represented by the above-mentioned formula (1), derived from N-vinylpyrrolidone, is preferably 80% by mol or more, and more preferably 90% by mol or more relative to all of the structural units. If the proportion of the structural unit derived from N-vinylpyrrolidone is less than 80% by mol, various properties attributed to N-vinylpyrrolidone may be insufficiently exhibited.

The vinylpyrrolidone polymer of the present invention has a K value according to Fikentscher method of 60 or less, and preferably 48 or less, and more preferably 42 or less, and still more preferably 40 or less. A high concentration aqueous solution of a polymer having a K value of more than 60 generally becomes difficult to handle as the viscosity increases. In the present invention, the K value is a value determined in a Fikentscher formula using values obtained by measuring a solution for viscosity at 25° C. with a capillary viscometer, the solution being prepared by dissolving a vinylpyrrolidone polymer in any solvent at a concentration of 10% by weight or less. The Fikentscher formula is as follows.

log ηrel)/C=[(75 Ko²)/(1+1.5 KoC)]+Ko

### K=1000 Ko

C represents the number of grams of the vinylpyrrolidone copolymer in 100 mL of the solution. ηrel represents the viscosity of the solution to the solvent.

It is preferable that the vinylpyrrolidone polymer of the present invention has a molecular weight distribution (Mw/Mn) of 2.1 or less. If the molecular weight distribution (Mw/Mn) is more than 2.1, a problem of reduction in dispersion stability may be caused when the polymer is used as a dispersant, for example.

The vinylpyrrolidone polymer solution of the present invention is a 40 to 60% by weight solution of the above-mentioned vinylpyrrolidone polymer. The polymer solution is a 40% by weight or more high concentration solution, and therefore, if the vinylpyrrolidone polymer solution of the present invention is handled (stored and transported) as it is, redissolution of the polymer is not needed when the polymer is used as a solution, and advantages in terms of volumetric capacity, which equal or surpass those obtained in the polymer in powder form, can be obtained. However, if the concentration is more than 60% by weight, increase in viscosity is large, which leads to disadvantage of difficulty in handling. The concentration is preferably 40 to 60% by weight, and more preferably 49 to 60% by weight, and still more preferably 50 to 60% by weight. It is furthermore preferable that the concentration is 50% by weight or more for advantages in terms of volumetric capacity in transport or storage, which equal or surpass those obtained in the polymer in powder form.

The vinylpyrrolidone polymer solution of the present invention has an N-vinylpyrrolidone content of 10 ppm or less based on the vinylpyrrolidone polymer. If the N-vinylpyrrolidone is more than 10 ppm based on the vinylpyrrolidone polymer, the polymer solution can not be used in applications according to rule of Japanese pharmacopoeias, such as medical applications. Herein, the term “10 ppm or less” means that no N-vinylpyrrolidone is contained, that is, is a concept including “0 ppm of N-vinylpyrrolidone”.

In the vinylpyrrolidone polymer solution of the present invention, the alkanol concentration in the solution is 100 ppm or less. The alkanol concentration in the solution is preferably 10 ppm or less, more preferably 1 ppm or less, and most preferably 0 ppm. That is, it is most preferable that the solution has no alkanols. If the alkanol concentration is more than 100 ppm, the toxicity of the alkanol becomes a problem, and use of the solution in applications of medical products such as oral medicine and injectable solution is limited, for example.

The vinylpyrrolidone polymer solution of the present invention has an ignition residue of 0.1% by weight or less. If the ignition residue is more than 0.1% by weight, the polymer solution may not be used in applications according to the rule of Japanese pharmacopoeias, such as medical applications. The above-mentioned ignition residue is measured according to residue on ignition test of Japanese Pharmacopoeia.

A 50% solution of the vinylpyrrolidone polymer of the present invention has a hue (APHA) according to JIS-K3331 of 280 or less. The hue (APHA) is preferably 200 or less. If the solution at a concentration of 50%, that is, the solution having a vinylpyrrolidone polymer concentration of 50% by weight has a hue (APHA) of more than 280, coloring is remarkable, and such a solution can not be used in applications where coloring and color appearance are problematic, such as a cosmetics application, a coating material application, and an ink application. The above-mentioned hue (APHA) is according to JIS-K3331. The 50% by weight solution of the vinylpyrrolidone polymer of the present invention is measured for hue as it is. A 50% by weight or more solution of the vinylpyrrolidone polymer of the present invention is diluted to have a vinylpyrrolidone polymer concentration of 50% by weight and then measured for hue.

The vinylpyrrolidone polymer solution of the present invention contains an aqueous solvent. Aqueous solvents mentioned below in “production process of vinylpyrrolidone polymer solution” may be mentioned as the aqueous solvent, for example. One or two or more different aqueous solvents may be used.

The vinylpyrrolidone polymer solution of the present invention can be easily produced by the after-mentioned production process of the present invention. The polymer solution obtained in the polymerization reaction as it is can be used as the vinylpyrrolidone polymer solution of the present invention, but is not limited thereto. For example, the polymerization solution obtained in the polymerization reaction is appropriately diluted within the above-mentioned range of the vinylpyrrolidone polymer concentration, and used as the vinylpyrrolidone polymer solution of the present invention.

### “Production Process of Vinylpyrrolidone Polymer Solution”

The production process of vinylpyrrolidone polymer solution of the present invention is a process for producing a 40 to 60% by weight solution of a vinylpyrrolidone polymer having a K value according to Fikentscher method of 60 or less. The vinylpyrrolidone polymer is as mentioned above.

In the production process of the vinylpyrrolidone polymer solution of the present invention, a monomer component essentially containing N-vinylpyrrolidone, hydrogen peroxide, and ammonia are sequentially added in a copper catalyst-containing aqueous solvent and polymerized at 55 to 90° C.

The above-mentioned monomer component may include a monomer copolymerizable with N-vinylpyrrolidone, in addition to N-vinylpyrrolidone. The monomer copolymerizable with N-vinylpyrrolidone is not especially limited, and specific examples thereof include (1) (meth)acrylates such as methyl (meth)acrylate, ethyl (meth)acrylate, butyl (meth)acrylate, cyclohexyl (meth)acrylate, and hydroxyethyl (meth)acrylate; (2) (meth)acrylamide derivatives such as (meth)acrylamide, N-monomethyl (meth) acrylamide, N-monoethyl (meth) acrylamide, and N,N-dimethyl (meth)acrylamide; (3) basic unsaturated monomers such as dimethylaminoethyl (meth)acrylate, dimethylaminoethyl (meth)acrylamide, vinylpyridine, and vinylimidazole; (4) vinylamides such as vinylformamide, vinylacetamide, and vinyloxazolidone; (5) carboxyl group-containing unsaturated monomers such as (meth)acrylic acid, itaconic acid, maleic acid, and fumaric acid; (6) unsaturated acid anhydride such as maleic anhydride and itaconic anhydride; (7) vinyl esters such as vinyl acetate and vinyl propionate; (8) vinyl ethylene carbonate and derivatives thereof; (9) styrene and derivatives thereof; (10) (meth) acrylic acid-2-ethyl sulfonate and derivatives thereof; (11) vinylsulfonic acid and derivatives thereof (12) vinyl ethers such as methyl vinyl ether, ethyl vinyl ether, and butyl vinyl ether; (13) olefins such as ethylene, propylene, octene, and butadiene. Among these monomers, the monomers in (1) to (8) are particularly preferable in view of copolymerization with N-vinylpyrrolidone. One or two or more species of them may be used as the monomer copolymerizable with N-vinylpyrrolidone.

The proportion of the N-vinylpyrrolidone in the above-mentioned monomer component is not especially limited, and is preferably 80% by mol or more, and more preferably 90% by mol or more relative to the monomer component. If the proportion of the N-vinylpyrrolidone is less than 80% by mol relative to the monomer component, the obtained polymer solution may insufficiently exhibit various properties attributed to the N-vinylpyrrolidone.

The use amount of the above-mentioned monomer component may be appropriately determined in such a way that the concentration of the vinylpyrrolidone generated in the polymerization reaction is 40 to 60% by weight.

In the production process of the vinylpyrrolidone polymerization solution of the present invention, the use amount of the above-mentioned hydrogen peroxide is preferably 0.4 to 7% by weight relative to the N-vinylpyrrolidone in the above-mentioned monomer component.

The use amount of the hydrogen peroxide is more preferably 0.55 to 6% by weight and still more preferably 0.6 to 4% by weight. If the use amount of the hydrogen peroxide is less than 0.4% by weight, the molecular weight is increased and the K value of the generated vinylpyrrolidone polymer becomes more than 60. If the use amount thereof is more than 7% by weight, the obtained polymer solution may be easily colored. A hydrogen peroxide solution and the like may be generally used as the above-mentioned hydrogen peroxide.

In the production process of the vinylpyrrolidone polymer solution of the present invention, it is important that the use amount of the above-mentioned ammonia is 0.1 to 0.37% by weight and preferably 0.15 to 0.3% by weight relative to the N-vinylpyrrolidone in the above-mentioned monomer component. If the use amount of the ammonia is less than 0.1% by weight, the polymerization rate is significantly reduced. If the use amount thereof is more than 0.37% by weight, the obtained solution has a higher viscosity and a side reaction such as graft reaction is easily caused. Ease of generation of the side reaction is preferably determined by the after-mentioned molecular weight distribution measurement. It is preferable that the measurement value of the molecular weight distribution of the vinylpyrrolidone polymer in the above-mentioned polymerization reaction is 2.1 or less. If the molecular weight distribution is more than 2.1, such a solution may not be preferably used in various applications.

An ammonia solution and the like may be generally used as the above-mentioned ammonia. In the production process of the vinylpyrrolidone polymer solution of the present invention, the use amount of the above-mentioned copper catalyst is adjusted in such a way that an amount of copper ions contained in the catalyst is 20 to 300 ppb relative to the N-vinylpyrrolidone in the above-mentioned monomer component. The amount of copper ions contained in the catalyst is more preferably 100 to 300 ppb, and still more preferably 100 to 200 ppm. If the copper catalyst containing copper ions of less than 20 ppb is used, the polymerization rate is remarkably reduced and a side reaction such as decomposition proceeds. If the copper catalyst containing copper ions of more than 300 ppb is used, effects to meet the increase in the use amount can not be obtained, resulting in economic inefficiency.

Examples of the above-mentioned copper catalyst include copper sulfate, copper chloride, copper mitrate, copper acetate, and salts like a water-soluble copper complex that is inert to a polymerization reaction. One or two or more different copper catalysts may be used. Basically, it is no matter that the copper catalyst is mixed with water in the initial stages in order to simplify a polymerization device. However, the copper catalyst may be simultaneously added dropwise together with other raw materials in order to suppress heating in the initial stages of the polymerization if the copper catalyst amount is large. No difference in physical properties is observed between a polymer obtained in the case where the copper catalyst is simultaneously added dropwise together with other raw materials, and a polymer obtained in the case where the copper catalyst is mixed with water in the initial stages.

It is preferable that water is singly used as the above-mentioned aqueous solvent. In addition to water, an organic solvent may be appropriately contained. Examples of the organic solvent which can be contained together with water include alcohols such as methyl alcohol, ethyl alcohol, isopropyl alcohol, ethylene glycol, propylene glycol, 1,3-butanediol, 1,4-butanediol; ethers such as glycol ether, diethylene glycol, triethylene glycol, hexamethylene glycol, and polyethylene glycol; amines such as butylamine, cyclohexylamine, pyridine, morpholine, 2-aminoethanol, diethanolamine, triethanolamine, and aminoethylethanolamine. One or two or more different these organic solvents may be used. If these organic solvents are also contained, it is preferable that the content of these organic solvents is 100 ppm or less.

The use amount of the aqueous solvent is appropriately determined in such a way that the concentration of the vinylpyrrolidone polymer generated in the polymerization reaction is 40 to 60% by weight.

In the production process of the vinylpyrrolidone polymer solution of the present invention, the polymerization reaction is performed by sequentially adding the above-mentioned monomer component, the above-mentioned hydrogen peroxide, the above-mentioned ammonia in the above-mentioned copper catalyst-containing aqueous solvent. In the present invention, a high concentration solution having a vinylpyrrolidone polymer concentration of 40 to 60% by weight is obtained, as mentioned above. If each raw material is added together, heat generated by the reaction is large, which reduces safety. In the production process of the present invention, however, each raw material is sequentially added, thereby allowing the reaction to proceed. Therefore, the problem of heat generated by the reaction is avoided and the production can be safely performed. Specifically, the sequential addition may be continuous addition (for example, an embodiment is which dropwise addition is performed over a specific time) or may be intermittent addition (for example, an embodiment in which each raw material (monomer component, hydrogen peroxide, and ammonia) is added in some portions). Alternatively, the addition may be performed by a combination of the continuous addition and the intermittent addition. It is preferable that the monomer component, the hydrogen peroxide, and the ammonia are sequentially added separately, but may be sequentially added after previously mixed appropriately.

The N-vinylpyrrolidone, the hydrogen peroxide, and the ammonia are sequentially added, and then if necessary, 0.01 to 1.0% ammonia may be arbitrarily added, thereby accelerating reduction in residual monomers. The addition method is not especially limited, and en bloc addition and continuous addition may be used. The preferable range of the ammonia is 0.01 to 0.7%, and more preferably 0.05 to 0.5%.

In the production process of the vinylpyrrolidone polymer solution of the present invention, it is important to perform the above-mentioned polymerization reaction at 55 to 90° C. Specifically, it is important that the polymer reaction is started when the monomer component, the hydrogen peroxide, and the ammonia all exist in the aqueous solvent, and the temperature inside the reaction system (aqueous solvent) is maintained within the above-mentioned range from the beginning of the polymerization. If the polymerization reaction is performed at a temperature of less than 55° C., the molecular weight tends to increase, which fails to control the K value of the obtained polymer to 60 or less. If the polymerization reaction is performed at a temperature of more than 90° C., decomposition reaction of the raw material monomer or the generated polymer is accelerated, possibly causing coloring. It is preferable that the reaction temperature was 55 to 90° C. during most of the above-mentioned polymerization reaction.

In the above-mentioned polymerization reaction, a transfer agent, a cocatalyst, a pH adjustor, a buffer, and the like may be used if necessary, unless the effects of the present invention are sacrificed. During or after the above-mentioned polymerization reaction, various additives for improving the physical properties or performances of the obtained polymer solution, such as an antioxidant, a process stabilizer, a plasticizer, a dispersant, a filler, an antioxidant, a pigment, and a curing agent, may be appropriately added unless the effects of the present invention are sacrificed.

### “Method of Handling Vinylpyrrolidone Polymer”

The method of handling a vinylpyrrolidone polymer of the present invention is a method of handing a vinylpyrrolidone polymer having a K value according to Fikentscher method of 60 or less as the above-mentioned vinylpyrrolidone polymer solution of the present invention. If the vinylpyrrolidone polymer is handled as a high concentration solution like the above-mentioned vinylpyrrolidone polymer solution of the present invention, redissolution of the polymer is not needed when the polymer is used in solution form. In addition, advantages in terms of volumetric capacity in storage or transport, which equal or surpass those obtained in the polymer in powder form, can be obtained.

The “handling” used in the present invention means operations at every stages from production to use, such as storage and transport. Specifically, according to the method of handling the vinylpyrrolidone of the present invention, the vinylpyrrolidone polymer in the form of the above-mentioned vinylpyrrolidone polymer solution of the present invention is stored and transported by a tanker and the like, or put in a drum and stored and transported, or transported through pipe lines from a production site to a use site, for example.

### EFFECT OF THE INVENTION

According to the present invention, a high concentration solution of a vinylpyrrolidone polymer having a low K value, which is usable in various applications including medical applications and applications where coloration is problematic, can be easily obtained. Such a vinylpyrrolidone polymer solution is handled (stored and transported) as it is, and therefore redissolution is not need when the polymer is used in solution form, and advantages in terms of volumetric capacity in storage or transport, which equal or surpass those obtained in the polymer in powder form, can be obtained.

### BEST MODE FOR CARRYING OUT THE INVENTION

The present invention is mentioned in more detail below with reference to Examples, but is not limited to thereto. Hereinafter, the terms, “part(s) by weight” and “% by weight” are represented by simply “part (s)” and “%”, respectively, unless otherwise specified.

Physical properties of aqueous solutions obtained in Examples were measured by the following methods, respectively.

### “Concentration”

The obtained aqueous solution about 2 g was weighed (this weight was defined as x (g)) and dried at 150° C. for 1 hour. The nonvolatile matter after drying was regarded as polyvinylpyrrolidone and was measured for weight (this weight after drying was defined as y(g)). Then, the concentration was calculated from the following formula.

Concentration (%)=(y/x)*100

### “K Value”

The obtained aqueous solution was diluted, thereby the concentration of the polyvinylpyrrolidone was adjusted to 1%. This diluted solution was measured for viscosity at 25° C. with a capillary viscometer. Based on the obtained measurement value, the K value was calculated from the above-mentioned Fikentscher formula.

### “Ignition Residue”

According to residue on ignition test of the Japanese Pharmacopoeia, the obtained aqueous solution about 1 g (this weight was defined as x (g)) was weighed and dried by heating. The obtained residue was ashed by adding concentrated sulfuric acid thereto. The obtained ash was further heated at 500° C. and left to cool, and then measured for weight (this weight was defined as y (g)). Then, the ignition residue was calculated from the following formula.

Ignition residue (ppm)=(y/x)*100

### “Hue (50% APHA)”

According to JIS-K3331, an aqueous solution in which the nonvolatile matter was adjusted to 50% was measured for APHA.

### “Residual N-Vinylpyrrolidone Amount”

Quantitative analysis was carried out at an absorption intensity of 235 nm by liquid chromatography to determine an amount of N-vinylpyrrolidone existing in the aqueous solution. The N-vinylpyrrolidone amount relative to the polyvinylpyrrolidone amount calculated based on the concentration was represented by ppm.

### “Molecular Weight Distribution Measurement”

The molecular weight distribution (Mw/Mn) was measured using GPC (gel permeation chromatography) produced by Shimazu Corp.; “LF804 (trade name)” and “KD801 (trade name)” produced by Shodex Corp. as a column; and DMF and 1% KBr as an eluent, at a flow rate of 0.8 mL/min and at a column temperature of 40° C.

### EXAMPLE 1

Copper sulfate 0.00023 parts (the amount of the copper catalyst relative to N-vinylpyrrolidone was 200 ppb) and water 426.3 parts were charged into a reaction container and heated to 80° C. While the temperature was maintained at 80° C., N-vinylpyrrolidone 450 parts, 25% ammonia water 3.6 parts (the amount of the ammonia relative to the N-vinylpyrrolidone was 0.2%), and 35% hydrogen peroxide solution 15 parts were separately added dropwise over 180 minutes. After completion of the dropwise addition, 35% hydrogen peroxide solution 4.5 parts (the amount of the hydrogen peroxide solution relative to the N-vinylpyrrolidone was 2.9%) was evenly added in five batches at 1-hour intervals. After the fifth addition, the reaction solution was further maintained at 80° C. for 1 hour to produce a polyvinylpyrrolidone aqueous solution. The obtained polyvinylpyrrolidone aqueous solution was measured for physical properties. The aqueous solution had a polyvinylpyrrolidone concentration of 50%, a K value of 30, an ignition residue of 1 ppm or less, a hue (50% APHA) of 160, and a residual N-vinylpyrrolidone amount of 10 ppm or less relative to the polyvinylpyrrolidone. The obtained polyvinylpyrrolidone aqueous solution had an alkanol concentration of 0 ppm, because no alkanol was used in the production. The aqueous solution had a molecular weight distribution of 2.0.

### EXAMPLE 2

A polyvinylpyrrolidone aqueous solution was obtained in the same manner as in Example 1, except that the water amount was changed to 330.5 parts. The obtained polyvinylpyrrolidone aqueous solution was measured for physical properties. The aqueous solution had a polyvinylpyrrolidone concentration of 56%, a K value of 33, an ignition residue of 1 ppm or less, a hue (50% APHA) of 160, and a residual N-vinylpyrrolidone amount of 10 ppm or less relative to the polyvinylpyrrolidone. The obtained polyvinylpyrrolidone aqueous solution had an alkanol concentration of 0 ppm, because no alkanol was used in the production. The aqueous solution had a molecular weight distribution of 2.0.

### EXAMPLE 3

Copper sulfate 0.00023 parts (the amount of the copper catalyst relative to N-vinylpyrrolidone was 200 ppb) and water 384.3 parts were charged into a reaction container and heated to 60° C. While the temperature was maintained at 60° C., N-vinylpyrrolidone 450 parts, 25% ammonia water 3.6 parts (the amount of the ammonia relative to the N-vinylpyrrolidone was 0.2%), and 35% hydrogen peroxide solution 57 parts were separately added dropwise over 180 minutes. After completion of the dropwise addition, 35% hydrogen peroxide solution 4.5 parts (the amount of the hydrogen peroxide solution relative to the N-vinylpyrrolidone was 2.9%) was evenly added in five batches at 1-hour intervals. After the fifth addition, the reaction solution was further maintained at 80° C. for 1 hour to produce a polyvinylpyrrolidone aqueous solution. The obtained polyvinylpyrrolidone aqueous solution was measured for physical properties. The aqueous solution had a polyvinylpyrrolidone concentration of 50%, a K value of 15, an ignition residue of 1 ppm or less, a hue (50% APHA) of 160, and a residual N-vinylpyrrolidone amount of 10 ppm or less relative to the polyvinylpyrrolidone. The obtained polyvinylpyrrolidone aqueous solution had an alkanol concentration of 0 ppm, because no alkanol was used in the production. The aqueous solution had a molecular weight distribution of 1.8. The reaction time was 13 hours.

### EXAMPLE 4

Copper sulfate 0.00023 parts (the amount of the copper catalyst relative to N-vinylpyrrolidone was 200 ppb) and water 432.7 parts were charged into a reaction container and heated to 80° C. While the temperature was maintained at 80° C., N-vinylpyrrolidone 450 parts, 25% ammonia water 3.6 parts (the amount of the ammonia relative to the N-vinylpyrrolidone was 0.2%) and 35% hydrogen peroxide solution 8.6 parts were separately added dropwise over 180 minutes. After completion of the dropwise addition, 35% hydrogen peroxide solution 4.5 parts (the amount of the hydrogen peroxide solution relative to the N-vinylpyrrolidone was 2.9%) was evenly added in five batches at 1-hour intervals. After the fifth addition, the reaction solution was further maintained at 80° C. for 1 hour to produce a polyvinylpyrrolidone aqueous solution. The obtained polyvinylpyrrolidone aqueous solution was measured for physical properties. The aqueous solution had a polyvinylpyrrolidone concentration of 50%, a K value of 40, an ignition residue of 1 ppm or less, a hue (50% APHA) of 150, and a residual N-vinylpyrrolidone amount of 10 ppm or less relative to the polyvinylpyrrolidone. The obtained polyvinylpyrrolidone aqueous solution had an alkanol concentration of 0 ppm, because no alkanol was used in the production. The aqueous solution had a molecular weight distribution of 2.1.

### EXAMPLE 5

Water 426.3 g was charged into a reaction container and heated to 80° C. While the temperature was maintained at 80° C., N-vinylpyrrolidone 450 parts, 25% ammonia water 3.6 parts (the amount of ammonia relative to the N-vinylpyrrolidone was 0.2%), copper sulfate 0.00023 parts (the amount of the copper catalyst relative to the N-vinylpyrrolidone was 200 ppb), and 35% hydrogen peroxide solution 9.5 parts were separately added dropwise over 180 minutes. After completion of the dropwise addition, 35% hydrogen peroxide solution 4.5 parts (the amount of the hydrogen peroxide solution relative to the N-vinylpyrrolidone was 2.9%) was evenly added in five batches at 1-hour intervals. After the fifth addition, the reaction solution was further maintained at 80° C. for 1 hour to produce a polyvinylpyrrolidone aqueous solution. The obtained polyvinylpyrrolidone aqueous solution was measured for physical properties. The aqueous solution had a polyvinylpyrrolidone concentration of 50%, a K value of 30, an ignition residue of 1 ppm or less, a hue (50% APHA) of 160, a residual N-vinylpyrrolidone amount of 10 ppm or less relative to the polyvinylpyrrolidone, and a molecular weight distribution of 2.0. The obtained polyvinylpyrrolidone aqueous solution had an alkanol concentration of 0 ppm, because no alkanol was used in the production. The aqueous solution had a molecular weight distribution of 2.0.

### EXAMPLE 6

Water 426.3 parts was charged into a reaction container and heated to 60° C. While the temperature was maintained at 60° C., N-vinylpyrrolidone 450 parts, 25% ammonia water 3.6 parts (the amount of the ammonia relative to N-vinylpyrrolidone was 0.2%), copper sulfate 0.00023 parts (the amount of the copper catalyst relative to the N-vinylpyrrolidone was 200 ppb), and 35% hydrogen peroxide solution 57 parts were separately added dropwise over 180 minutes. After completion of the sequential dropwise addition of each raw material, 25% ammonia water 9.0 parts (the amount of the ammonia relative to the N-vinylpyrrolidone was 0.5%) was added dropwise over 180 minutes. Six hours later after the reaction was started, 35% hydrogen peroxide solution 2.4 parts (the amount of the hydrogen peroxide relative to the N-vinylpyrrolidone was 6.2%) was added and the reaction solution was further maintained at 60° C. for 1 hour. As a result, a polyvinylpyrrolidone aqueous solution was obtained. The obtained polyvinylpyrrolidone aqueous solution was measured for physical properties. The aqueous solution had a polyvinylpyrrolidone concentration of 50%, a K value of 15, an ignition residue of 1 ppm or less, a hue (50% APHA) of 160, and a residual N-vinylpyrrolidone amount of 10 ppm or less relative to the polyvinylpyrrolidone. The obtained polyvinylpyrrolidone aqueous solution had an alkanol concentration of 0 ppm, because no alkanol was used in the production. The aqueous solution had a molecular weight distribution of 2.0. The reaction time in this Example was 7 hours and could be significantly shortened in comparison to 13 hours that was a reaction time in Example 3.

### COMPARATIVE EXAMPLE 1

Copper sulfate 0.00023 parts (the amount of the copper catalyst relative to N-vinylpyrrolidone was 200 ppb) and water 426.3 parts were charged into a reaction container and heated to 95° C. While the temperature was maintained at 95° C., N-vinylpyrrolidone 450 parts, 25% ammonia water 3.6 parts (the amount of the ammonia relative to the N-vinylpyrrolidone was 0.2%), and 35% hydrogen peroxide solution 15 parts were separately added dropwise over 180 minutes. After completion of the dropwise addition, 35% hydrogen peroxide solution 4.5 parts (the amount of the hydrogen peroxide solution relative to the N-vinylpyrrolidone was 2.9%) was evenly added in five batches at 1-hour intervals. After the fifth addition, the reaction solution was further maintained at 95° C. for 1 hour to produce a polyvinylpyrrolidone aqueous solution. The obtained polyvinylpyrrolidone aqueous solution was measured for physical properties. The aqueous solution had a polyvinylpyrrolidone concentration of 50%, a K value of 30, an ignition residue of 0.1% or less, a hue (50% APHA) of 330, and a residual N-vinylpyrrolidone amount of 10 ppm or less relative to the polyvinylpyrrolidone. The obtained polyvinylpyrrolidone aqueous solution had an alkanol concentration of 0 ppm, because no alkanol was used in the production. The aqueous solution had a molecular weight distribution of 2.0.

### COMPARATIVE EXAMPLE 2

Copper sulfate 0.00023 parts (the amount of the copper catalyst relative to N-vinylpyrrolidone was 200 ppb) and water 426.3 parts were charged into a reaction container and heated to 100° C. While the temperature was maintained at 100° C., N-vinylpyrrolidone 450 parts, 25% ammonia water 3.6 parts (the amount of the ammonia relative to the N-vinylpyrrolidone was 0.2%), and 35% hydrogen peroxide solution 15 parts (the amount of the hydrogen peroxide relative to the N-vinylpyrrolidone was 2.9%) were separately added dropwise over 180 minutes. After completion of the dropwise addition, 35% hydrogen peroxide solution 4.5 parts was evenly added in five batches at 1-hour intervals. After the fifth addition, sodium sulfite 2.5 parts was added and the reaction solution was further maintained at 100° C. for 1 hour to produce a polyvinylpyrrolidone aqueous solution. The obtained polyvinylpyrrolidone aqueous solution was measured for physical properties. The aqueous solution had a polyvinylpyrrolidone concentration of 50%, a K value of 30, an ignition residue of 0.2% or more, a hue (50% APHA) of 160, and a residual N-vinylpyrrolidone amount of 10 ppm or less relative to the polyvinylpyrrolidone. The obtained polyvinylpyrrolidone aqueous solution had an alkanol concentration of 0 ppm, because no alkanol was used in the production. The aqueous solution had a molecular weight distribution of 2.0.

### COMPARATIVE EXAMPLE 3

Copper sulfate 0.00023 parts (the amount of the copper catalyst relative to N-vinylpyrrolidone was 200 ppb) and water 426.3 parts were charged into a reaction container and heated to 60° C. While the temperature was maintained at 60° C., N-vinylpyrrolidone 450 parts, 25% ammonia water 10.8 parts (the amount of the ammonia relative to the N-vinylpyrrolidone was 0.6%), and 35% hydrogen peroxide solution 57 parts (the amount of the hydrogen peroxide relative to the N-vinylpyrrolidone was 6.2%) were separately added dropwise over 180 minutes. After completion of the dropwise addition, the reaction solution was maintained at 80° C. for 5 hours and a 35% hydrogen peroxide solution 4.5 parts was evenly added in five batches at 1-hour intervals. After the fifth addition, the reaction solution was further maintained at 80° C. for 1 hour to produce a polyvinylpyrrolidone aqueous solution. The obtained polyvinylpyrrolidone aqueous solution was measured for physical properties. The aqueous solution had a polyvinylpyrrolidone concentration of 50%, a K value of 19, an ignition residue of 1 ppm or less, a hue (50% APHA) of 160, and a residual N-vinylpyrrolidone amount of 100 ppm or more relative to polyvinylpyrrolidone. The obtained polyvinylpyrrolidone aqueous solution had an alkanol concentration of 0 ppm, because no alkanol was used in the production. The aqueous solution had a molecular weight distribution of 2.2.

### INDUSTRIAL APPLICABILITY

The vinylpyrrolidone polymer solution, the process for producing such a solution, the method of handling a vinylpyrrolidone polymer using such a solution, according to the present invention, can be preferably used in various applications, for example, a cosmetics application; an application of medical products and additives for medical products, such as a disintegrator, a solubilizing agent, a binder for tablets, and a complex with iodine; an application of detergent additives such as an anti-soil redeposition agent and a color-transfer inhibitor; and industrial applications of dispersants for metallic fine particles or organic/inorganic pigments, cohesives, adhesives, additives for photoresist or ink, conductive layers, and solid electrolytes. They are particularly useful in applications where a vinylpyrrolidone polymer having a K value of 60 or less is used as a solution, and coloring and an ignition residue are problematic.

1. A 40 to 60% by weight solution of a vinylpyrrolidone polymer having a K value according to Fikentscher method of 60 or less,
wherein the solution has: an N-vinylpyrrolidone content of 10 ppm or less relative to the vinylpyrrolidone polymer; an alkanol concentration of 100 ppm or less; and an ignition residue of 0.1% by weight or less, and
a 50% by weight solution of the vinylpyrrolidone polymer has a hue (APHA) according to JIS-K3331 of 280 or less.

2. A process for producing a 40 to 60% by weight solution of a vinylpyrrolidone polymer having a K value according to Fikentscher method of 60 or less,
wherein a monomer component comprising N-vinylpyrrolidone, hydrogen peroxide, and ammonia are sequentially added to a copper catalyst-containing aqueous solvent and polymerized at 55 to 90° C., and the ammonia is used in an amount of 0.1 to 0.37% by weight based on the N-vinylpyrrolidone.

3. A method of handling a vinylpyrrolidone polymer, wherein a vinylpyrrolidone polymer having a K value according to Fikentscher method of 60 or less is handled as the vinylpyrrolidone polymer solution of claim 1.
